(19) United States
(12) Patent Application Publication
(10) Pub. No.: US 2024/0323627 A1
(43) Pub. Date: Sep. 26, 2024

(54) SYSTEM FOR OUTPUTTING AUDIO FOR A USER, AND A METHOD THEREOF

(71) Applicant: Sony Interactive Entertainment Inc., Tokyo (JP)

(72) Inventor: Jun Yen Leung, London (GB)

(73) Assignee: Sony Interactive Entertainment Inc., Tokyo (JP)

(21) Appl. No.: 18/599,596

(22) Filed: Mar. 8, 2024

(30) Foreign Application Priority Data
Mar. 21, 2023 (GB) 2304077.7

(51) Int. Cl. H04S 3/00; H04R 5/033

(52) U.S. Cl. CPC H04S 3/008; H04R 5/0335; H04R 2460/13; H04R 2499/11; H04R 2499/15; H04S 2420/01

(57) ABSTRACT

A system for outputting audio for a user, comprising processing circuitry configured to generate, based at least in part on an audio file, a plurality of audio channels, and three or more transducers comprised within one or more audio output apparatuses wearable by the user, wherein the three or more transducers comprise at least one earphone/headphone and at least one bone conduction headphone, wherein each earphone/headphone is operable to emit one or more sound signals in dependence upon a first subset of the audio channels, and wherein each bone conduction headphone is operable to vibrate responsive to a second subset of the audio channels.

### FIELD OF INVENTION

The present invention relates to a system for (and method of) outputting audio for a user.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Since the introduction of the Sony® Walkman® in 1979, the popularity of personal audio systems has only increased, as users of such system are able to conveniently listen to audio (music, film/videogame soundtrack and/or sound effects, or the like) while on the go. Such systems typically comprise a portable audio device (such as the Sony® Walkman® or other music players, or smartphones, laptops, tablets, or the like) and earphones or headphones connected to the device so that audio output from the device is provided only to the user(s) of the portable audio device. Other personal audio systems may comprise entertainment devices (such as TVs, desktop computers, video games consoles, or the like) instead of/in addition to portable audio devices.

However, given that commonly known earphones/headphones typically have a maximum of two speakers (one for each of the user's ears), users have thus far been limited to experiencing only stereo audio (that is, 2-channel audio) when using their personal audio system.

The present invention seeks to alleviate or mitigate this issue.

### SUMMARY OF THE INVENTION

In a first aspect, a system for outputting audio for a user is provided in claim 1.

In another aspect, a method of outputting audio for a user is provided in claim 12.

Further respective aspects and features of the invention are defined in the appended claims.

### BRIEF DESCRIPTION OF THE DRAWING

Embodiments of the present invention will now be described by way of example with reference to the accompanying drawings, in which:

FIG. 1 schematically illustrates a system according to embodiments of the present description;

FIG. 2 is a schematically illustrates a commonly-known audio output device comprising a single headphone;

FIG. 3 schematically illustrates commonly-known bone conduction headphones;

FIGS. 4A and 4B schematically illustrate non-limiting examples of a user wearing commonly-known earphones/headphones and commonly-known bone conduction headphones together as part of a system according to embodiments of the present description;

FIG. 5 schematically illustrates a system according to embodiments of the present description;

FIGS. 6A-6C schematically illustrate non-limiting examples of audio output apparatuses according to embodiments of the present description;

FIGS. 7A-7C schematically illustrate non-limiting examples of a user wearing non-limiting examples of audio output apparatuses according to embodiments of the present description;

FIG. 8 schematically illustrates a system according to embodiments of the present description;

FIG. 9 schematically illustrates a system according to embodiments of the present description;

FIG. 10 schematically illustrates an entertainment device according to embodiments of the present description; and

FIG. 11 schematically illustrates a method according to embodiments of the present description.

### DESCRIPTION OF THE EMBODIMENTS

A system for outputting audio for a user, and a method thereof are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

As mentioned previously, users have thus far been limited to experiencing stereo audio when using their personal audio system. That is to say, users have heretofore not been able to experience surround sound (also known as 3D sound) when using their personal audio systems. Indeed, users desiring a richer and more immersive listening experience than that provided by stereo audio have typically had to possess a conventional room-scale surround sound system; that is, an audio system comprising a plurality of loudspeakers and (optionally) a subwoofer positioned at distinct locations within a room.

As will be appreciated by persons skilled in the art, while room-scale surround sound systems provided a richer audio experience, they lack the portability and privacy of personal audio systems and are often more expensive than personal audio systems. Thus, there is a need in the art to provide a richer and more immersive listening experience to users of personal audio systems, for instance through the use of additional audio channels to provide an improved directionality of audio being provided to the user of such a personal audio system.

Embodiments of the present description seek to address this need by providing a surround sound personal audio system which comprises earphones/headphones (which transmit sound waves through the user's ear canal) as well as bone conduction headphones (which transmit vibrations through the user's skull).

### A System for Outputting Audio for a User

Accordingly, turning now to FIG. 1, in embodiments of the present description, a system for outputting audio for a user comprises processing circuitry 100 configured to generate, based at least in part on an audio file, a plurality of audio channels; and three or more transducers comprised within one or more audio output apparatuses wearable by the user, wherein each transducer is an carphone/headphone 102 or a bone conduction headphone 104, wherein the three or more transducers comprise at least one carphone/headphone 102 and at least one bone conduction headphone 104; wherein each carphone/headphone 102 is operable to emit one or more sound signals in dependence upon a first subset of the audio channels; and wherein each bone conduction headphone 104 is operable to vibrate responsive to a second subset of the audio channels.

In essence, embodiments of the present description relate to a personal surround sound system that is able to output audio that comprises three or more audio channels to users, as opposed to the stereo (2-channel) audio that has thus far typically been provided by commonly known personal audio systems. Such surround sound capability is achieved by using earphones/headphones (which transmit sound waves through the user's ear canal) in conjunction with bone conduction headphones (which transmit vibrations through the user's skull). In other words, a surround sound effect is able to be provided in embodiments of the present description using two different audio transmission methods to deliver respective audio signals to the user.

To fully realise the richer and more immersive listening experience associated with surround sound systems, each of the three or more audio channels may comprise a different part of the audio defined in the audio file and/or a different rendering of the audio. For example, the audio file in question may be a rock song. Accordingly, the audio of each musical instrument of the rock band may be comprised within different audio channels, and/or a different equalisation/mixing of the audio may be comprised within different audio channels. In some embodiments, respective audio transmission characteristics associated with the different audio transmission methods may also be considered when generating respective outputs-for instance, by emphasising particular frequencies in some channels but not others to account for differences in transmission paths.

By doing so, audio objects/sound sources (musical instruments, sound effects, or the like) within the audio may be perceived by the user as coming from different locations with respect to the user. Using the rock song example, the lead singer of the rock band may be perceived as being positioned straight ahead of the user (that is, at a clock bearing of 12 o'clock with respect to the user), whereas the lead guitar may be perceived as being positioned to the left of the user (that is, at a clock bearing of, say, 10 o'clock with respect to the user).

As an entirely non-limiting example of the system in operation, a user may be wearing a pair of “off-the-shelf” earphones (two earphones 102) and a set of off-the-shelf bone conduction (BC) headphones (two headphones 104). The user may wish to listen to an audio file (a piece of music, a film's/videogame's soundtrack and/or sound effects, or the like), and so connects their portable audio device (a music player, smartphone, laptop, tablet, portable games console, or the like) to their earphones 102 and BC headphones 104 (using wired and/or wireless connection means) and select the audio file they want to listen to, the selection being carried out using a touchscreen, a keyboard, a trackpad, one or more buttons, triggers, thumbsticks, or the like, disposed on the portable music device.

Subsequently, one or more processors of the portable audio device (processing circuitry 100) may generate, based on the audio file (and optionally other data/metadata such as values relating to the localisation, gain, reverb, or the like, associated with parts of the audio file), four audio channels (given that there are four transducers in total). Ideally, all of the generated audio channels are different from each other.

In one non-limiting example, this difference in audio channels may be due to processing circuitry 100 dedicating a given audio object/sound source comprised within the audio file (a musical instrument, a sound effect, or the like) to one audio channel, and not dedicating that given audio object/sound source to any of the other audio channels. Alternatively or in addition, this difference may be due to processing circuitry 100 dedicating a different equalisation of the given audio object/sound source (emphasise the bass range of a piano, for example) to one audio channel, and not dedicating that equalisation to any of the other audio channels (for example, different equalisations that emphasise the tenor, alto and soprano ranges of the same piano may be distributed among the other audio channels).

Subsequently, earphones 102 may be driven (that is, made to emit sound signals) using a first subset of the audio channels generated by processing circuitry 100, and likewise the BC headphones 104 may be driven (that is, made to vibrate) using a second subset. The first subset may comprise two audio channels, one for each carphone 102. Similarly, the second subset may comprise two audio channels, one for each BC headphone 104. Accordingly, it will be appreciated by a person skilled in the art that each earphone/headphone 102 need not be driven by all audio channels comprised within the first subset, and similarly that each BC headphone 104 need not be driven by all audio channels comprised within the second subset. Rather, the first subset of audio channels should be construed as comprising those generated audio channels which are to be utilised to drive at least one of the earphones/headphones 102, and the second subset of audio channels should be construed as comprising those generated audio channels which are to be utilised to drive at least one of the BC headphones 104.

By simultaneously driving the transducers (that is, earphones 102 and BC headphones 104) in the aforementioned manner (by synchronising the parallel distribution of audio channels to the transducers, for example), the user is provided with a more immersive listening experience akin to that of conventional surround sound systems. This is because the audio defined in the selected audio file has been distributed among four audio channels as opposed to only two (which has been the norm heretofore).

### Processing Circuitry

In embodiments of the present description, processing circuitry 100 is configured to generate, based at least in part on an audio file, a plurality of audio channels. In embodiments of the present description, processing circuitry 100 may be one or more CPUs, one or more GPUs, and/or one or more TPUs.

Within the context of the present description, term “audio file” should be taken to mean a data file that comprises audio data pertaining to a particular piece of content. This piece of content may be a piece of music, a film, a videogame, a sound recording, or the like. The audio file may comprise a plurality of so-called “tracks”, where each track typically comprises audio data of (part of) a respective audio object/sound source associated with the content. For example, for a piece of rock music, the audio data of the singer may be comprised within a first track, the audio data of the lead guitar may be comprised within a second, the rhythm guitar a third, the bass guitar a fourth, and the drums may be split across two or more tracks (the bass and tom drums in one, the cymbals and snare in another, for example).

The audio file in question may come in any suitable format (compressed or uncompressed). For example, suitable compressed audio file formats may include MP3, AAC, FLAC, ALAC and the like, and suitable uncompressed audio file formats may include WAV, AIFF, DSD, PCM and the like. Where the audio file is in a compressed format, processing circuitry 100 may be configured to decompress the audio file prior to generating the audio channels.

The audio file in question may be received by processing circuitry 100 from any one or more suitable devices and/or components. For example, the audio file may be retrieved from a memory comprised within the same device as that comprising processing circuitry 100 (a RAM, ROM, SSD, flash drive, or the like), or may be transmitted from a device different from that comprising processing circuitry 100 via a network (such as the Internet, LAN, WLAN, and the like) or via a wired or wireless connection method (such as USB, Ethernet, a headphone jack/aux cable, Bluetooth®, Wi-Fi®, and the like).

In any case, once the audio file is received by the processing circuitry 100, or the device comprising this circuitry, the plurality of audio channels may be generated.

Within the context of the present description, the term “audio channel” should be taken to mean a data signal which is used to drive a transducer in order to generate sounds for the user. As mentioned previously, the transducer in question may be an earphone/headphone 102, sound signals generated therefrom being transmitted through the user's ear canal, for example. Alternatively, the transducer may be a BC headphone 104, the vibrations emitted therefrom being conducted through the temporal bone of the user's skull, for example.

In order to determine the number of audio channels to be generated, processing circuitry 100 may be configured to determine the number of transducers with which it is connected. Typically, one audio channel is dedicated to each transducer, and so to determine the number of audio channels to be generated, processing circuitry 100 may determine the number of transducers connected to the processing circuitry. While more audio channels can be generated by processing circuitry 100, skilled persons in the art will appreciate that dedicating more than one audio channel to a given transducer is largely equivalent to dedicating only one channel to the given transducer; this is because driving a given transducer with two audio channels is largely equivalent to driving the given transducer with one audio channel that comprises the data signals of the two aforementioned audio channels. Thus, the processing circuitry 100 may be configured to determine a total number of the plurality of audio channels to be generated in dependence upon a total number of transducers connected thereto.

For example, in a case where processing circuitry 100 is comprised within a device different from that of the transducers (a smartphone, tablet, portable games console, or the like), then processing circuitry 100 may detect one or more transducers that have been connected using wired connections means by detecting that a tip (and, if applicable, a first ring) of a tip-sleeve (TS), tip-ring-sleeve (TRS), or tip-ring-ring-sleeve (TRRS) audio jack is contacting the electrical contacts of the device's audio socket, for example. For example, if only a tip is contacting one of the electrical contacts, then processing circuitry 100 may determine that only one audio channel is connected by wired connection means, whereas if a tip and the first ring is contacting two different electrical contacts, then processing circuitry 100 may determine that two audio channels (left and right headphones, for example) are connected in such a manner. As will be appreciated by persons skilled in the art, this detection method is equally applicable to other wired connection means such as USB, Ethernet, HDMI, or the like.

Alternatively or in addition, processing circuitry 100 may detect one or more transducers that have been connected using wireless connections means by reading data transmitted thereto by the wireless audio device comprising the transducers. For example, when connecting a smartphone (that is, a device comprising processing circuitry 100) to a pair of wireless earphones/headphones or wireless BC headphones (that is, a wireless audio device comprising transducers) via Bluetooth®, information about the current status of the wireless audio device may be transmitted to the smartphone such as the make and model of the wireless audio device and/or the remaining amount of battery power available to the wireless audio device before charging is required. Among such information may be an indication of the number of audio channels/transducers the wireless audio device supports (which is typically 1 or 2 for off-the-shelf wireless audio devices). As will be appreciated by persons skilled in the art, this detection method is equally applicable to other wired connection means such as Wi-Fi®, LAN, WLAN, the Internet, or the like.

In a case where processing circuitry 100 is comprised within the same device as that of the transducers (that is, where processing circuitry 100 are integrally connected), the detection of transducers may involve detecting the total number of transducers that are connected to the I/O bridge of the device, for example.

In any case, the total number of transducers (and hence the total number of audio channels to be generated by processing circuitry 100) may be found by tallying up the numbers of transducers connected via wired connection means, wireless connection means, and/or integrated connection means. Once the total number of audio channels to be generated has been determined, processing circuitry 100 may generate the audio channels based (at least in part) on the audio file.

Considering the audio file alone, processing circuitry 100 may distribute the plurality of audio tracks comprised within the audio file among the plurality of audio channels. As will be appreciated by persons skilled in the art, if the plurality of audio tracks exceeds the plurality of audio channels to be generated, then processing circuitry 100 may dedicate two or more audio tracks to one audio channel.

This distribution of audio tracks may be random in nature, with processing circuitry 100 dedicating each track to a randomly selected audio channel. Turning back to the rock song example, processing circuitry 100 may randomly distribute the audio tracks of the rock song among four audio channels such that the singer's audio data may be comprised within a first audio channel, the audio data of the lead guitar, snare drum and cymbals comprised within a second audio channel, the rhythm and bass guitars comprised within a third, and the bass and tom drums comprised within a fourth.

Alternatively, a rule-based distribution of audio tracks to audio channels may be employed. For example, a given rule may be that audio tracks whose bass frequency range predominates are to be used to generate an audio channel that is dedicated to a BC headphone 104, whereas audio tracks whose treble frequency range predominates are to be used to generate an audio channel that is dedicated to an carphone/headphone 102. Such a rule may exploit the skull's ability to emphasise bass frequencies; users tend to perceive their own voice as being deeper/lower when they are speaking compared to when they are listening to a recording of their voice, as the user's skull typically magnifies/emphasises the lower frequencies of the user's voice when speaking.

In order to distribute the audio tracks in accordance with the aforementioned rule, processing circuitry may be configured to perform spectral analysis on the plurality of audio tracks. Such spectral analysis may enable processing circuitry 100 to identify the predominant range of frequencies in a given audio track, and subsequently assign the given track based on the identified predominant frequency range and the aforementioned rule.

In any case, distributing the audio tracks among the three or more audio channels may result in a sound source localisation akin to that of conventional room-based surround sound system; each audio object/sound source may be perceived by the user as coming from one of three or more different directions. For example, a first audio channel may be dedicated to a left carphone/headphone 102, and so any audio objects/sound sources comprised within that first audio channel may be perceived as coming from a clock bearing of 9 o'clock with respect to the user, whereas a second audio channel may be dedicated to a right BC headphone 104, and so any audio objects/sound sources comprised within that second audio channel may be perceived as coming from a clock bearing of 2 o'clock with respect to the user, and so on.

Alternatively or in addition, and now considering the audio file in conjunction with other data/metadata, processing circuitry 100 may be configured to generate the plurality of audio channels in dependence upon one or more audio rendering parameters associated with the audio file. This may be advantageous in that the user is provided with a more immersive listening experience. For example, such rendering parameters may improve the sound source localisation capabilities of embodiments of the present description; audio objects/sound sources may be perceived by the user as coming from a direction that does not coincide with a location of one of the transducers, for example. Alternatively or in addition, the user may be provided with audio that sounds like it is being performed within a particular venue (a concert hall, a cathedral, and the like), for example. Alternatively or in addition, the user may be provided with a well-mixed and equalised audio, where audio objects/sound sources are not being “drowned out” by others, for example. In such implementations it is considered that any given track in the audio file may correspond to two or more channels of the output audio, as reproduction of a single track by more than one transducer can enable an improved localisation effect.

Alternatively or in addition, such rendering parameters may even be used to create a surround sound (multi-channel) listening experience from an audio file that only comprises one audio track (hereinafter referred to as a “mono” audio file). For example, processing circuitry 100 may generate, say, 3 audio channels from the mono audio track by utilising 3 different equalisations (rendering parameters) associated with the mono audio. For example, in order to generate the first audio channel, processing circuitry 100 may generate a first copy of the mono audio file and apply thereto a first equalisation (EQ) which emphasises the bass frequency range thereof. Similarly, processing circuitry 100 may generate a second copy of the mono audio and apply thereto a second EQ which emphasises the tenor and alto frequency ranges (also known as low mid and high mid frequency ranges) thereof for the second channel, and a third copy with a third EQ which emphasises the soprano/treble frequency range thereof for the third channel. These EQs may be associated with the mono audio file as metadata, as non-limiting example.

By doing so, the different frequency ranges of the audio file may be perceived by the user as coming from three different directions due to the locations of the three transducers being driven by the three generated audio channels. Moreover, this distribution of mono audio among multiple channels by considering frequency ranges may be utilised to enable audio object/sound source separation and localisation, especially if a given audio object/sound source's frequency range lies within the emphasised frequency range of the one of the three aforementioned EQs (although the frequency ranges may be defined freely, and a plurality of ranges may be specified for each channel as appropriate). Hence, persons skilled in the art will appreciate that processing circuitry 100 may be configured to generate more audio channels than there are audio tracks in the audio file.

As will be appreciated by persons skilled in the art, audio rendering parameters may thus be utilised by processing circuitry 100 in order to affect how the audio is perceived by the user. As non-limiting examples, the audio rendering parameters may be used by processing circuitry 100 to modify, for the audio in general and/or parts of the audio (such as specific tracks, specific periods of time within the audio, and the like), the localisation thereof, the gain/volume thereof, the gain/volume of specific frequency bands thereof, and/or modify/introduce/remove audio effects applicable thereto (reverb, chorus, delay, and the like).

One or more of these audio rendering parameters may be associated with the audio file as metadata. Alternatively or in addition, one or more of these audio rendering parameters may be associated with the audio file by virtue of the device comprising processing circuitry 100. For example, if processing circuitry 100 were comprised within, say, a smartphone/laptop/tablet, then one or more of the audio rendering parameters may be specified/modified by the user through an audio processing app/software. Using the aforementioned rock song example, the user may use the app/software to increase the amount of reverb applied to the rhythm guitar, increase a bass and/or low mid frequency band of the bass guitar's audio, and adjust the localisation of the lead singer's audio. Hence, and as will be appreciated by persons skilled in the art, these audio rendering parameters may be predetermined or user defined, immutable or dynamically adjustable.

Optionally, the one or more audio rendering parameters may comprise one or more selected from the list consisting of: (i) one or more head-related transfer functions, HRTFs; (ii) one or more mixing/equalisation parameters; and (iii) one or more channel indicators.

HRTFs may be used to impose a sense of direction on (parts of) the audio data, as, generally speaking, a HRTF is a response that characterizes how an car receives a sound from a point in space. Alternatively put, HRTFs may be used to adjust the localisation of (parts of) the audio.

Mixing/equalisation parameters may be thought of as audio effects (reverb, chorus, delay, and the like), gains/volumes of (parts of) the audio data, gains/volumes associated with certain frequency bands of (parts of) the audio data, and localisation of (parts of) the audio effect (through use of panning potentiometers or “pan pots”, as they are colloquially known).

Channel indicators may thought of as flags/tags/metadata associated with respective parts of the audio file (tracks, periods of time, and the like), each channel indicator providing an indication as to which generated audio channel the respective track is to be comprised within.

It should be noted that the preceding list of examples are not exhaustive; persons skilled in the art will appreciate that audio rendering parameters other than those mentioned previously are considered within the scope of the present description.

Regarding predetermined and user-defined rendering parameters, HRTFs, mixing/equalisation parameters, and channel indicators may enable sound engineers mixing/mastering the audio defined in the audio file prior to the release of the audio file (and/or end users post-release) to adjust (parts of) the audio as they so desire, the adjustment being effected through an audio processing software/app, for example.

Regarding dynamically adjustable rendering parameters, the audio file in question may comprise audio that changes with each listening. Such dynamic audio is typically comprised within video games, where the triggering of sections of incidental music and sound effects are dependent upon the characters, objects, actions, events and the like, encountered within a given gameplay session. In such case, the audio rendering parameters are typically generated in an on-the-fly manner, the generation typically being dependent on the locations and/or visibility of characters objects, actions, events and the like.

For example, audio rendering parameters for a gunshot sound effect may be generated in dependence upon the location/distance of the gun in question relative to the user's in-game character (gain/volume reduces with increased distance, and the pan pot's value changes with respect to the relative location of the gun).

As a non-limiting example, a user playing a video game may encounter an enemy, and the enemy may shoot at the user's in-game character. In order to provide a more immersive listening experience while playing the video game, the sound of the gunshot and the resulting sounds of the bullet in flight (that is, the “whizzing” of the bullet) may be adjusted in an on-the-fly manner such that the user perceives the bullet as travelling towards their in-game character.

Firstly, the localisation of the initial gunshot sound effect may be carried out by considering the location/orientation of the enemy with respect to the user's in-game character. For example, if the enemy was stood at a clock bearing of 1 o'clock with respect to the in-game character when the bullet was fired, then processing circuitry 100 may incorporate the corresponding gunshot sound effect within a plurality of audio channels based on one or more rendering parameters associated with the sound effect such that the user perceives the bullet as being fired from a 1 o'clock bearing.

For example, the gunshot sound effect comprised within the game audio file may be associated with a virtual pan pot value (which provides an indication as to the localisation of the sound effect). This virtual pan pot value may be dynamically adjusted by the game engine in dependence upon the location of the gun relative to the user's in-game character. Continuing on with the above example, the virtual pan pot value may therefore be set at 1 o'clock.

Processing circuitry 100 may subsequently generate a plurality of audio channels (less than or equal to the number of transducers being worn by the user) based on the gunshot sound effect and the pan pot value. For example, the gains/volumes of each audio channel may be adjusted based on the distance between a given audio channel's dedicated transducer and the 1 o'clock bearing (indicated by the pan pot value). For example, if off-the-shelf earphones 102 and off-the-shelf BC headphones 104 (that is, 4 channels) are being used, then the audio channel dedicated to the right BC headphone 104 may have the highest gain/volume value, given that this BC headphone 104 is situated at approximately 2 o'clock with respect to the user. The second highest gain/volume may be associated with the right carphone 102, given that it is situated at 3 o'clock. The third highest gain/volume may be associated with the left BC headphone 104, given that it is situated at 10 o'clock. The lowest gain/volume may be associated with the left earphone 102, given that it is situated at 9 o'clock (or an audio channel may not even be generated for this most distant transducer). Subsequently, when these generated audio channels are played to the user simultaneously, the user may perceive the sound of the gunshot as coming from a 1 o'clock bearing.

Secondly, the localisation of the “whizz” of the bullet may be carried out in much the same way as the gunshot sound effect, albeit that the virtual pan pot value (and thus the gains/volumes of the audio channels) must be dynamically updated based on the location the travelling bullet as it travels towards the user. That is to say, given that the bullet is moving towards the user, the sound of the bullet whizzing should also reflect this movement. For example, the bullet, though fired from a 1 o'clock bearing, may fly past the in-game character's left ear. That is to say, the bullet may at one point during its trajectory be at a 3 o'clock bearing.

While the dynamic adjustment of the virtual pan pot value is used to adjust the gains/volumes of the audio channels relative to each other (that is, which audio channel should be loudest/quietest and the like), the absolute gains/volumes of the audio channels should also be adjusted based on the location of the travelling bullet. As will be appreciated by persons skilled in the art, sound attenuates in accordance with an inverse square law with respect to distance. That is to say, a given audio object/sound source typically sounds louder to users the closer the audio object/sound source is to the user. Thus, in this gun whizzing example, the absolute gains/volumes of the audio channels should increase as the bullet approaches the user's left ear.

It should be noted that this dynamic adjustment of audio channels may be carried out using any (combination of) rendering parameters, not just pan pot values; skilled persons will appreciate that the above example is entirely non-limiting.

In any case, processing circuitry 100 may be configured to synchronise the plurality of audio channels. Again, this may be advantageous in that the user is provided with a more immersive listening experience. Turning to the aforementioned rock song example, if the audio channels were unsynchronised, then the different audio objects/sound sources would sound “out of time” with one another; the bass guitar may sound like it is ahead of the beat of the drums, whereas the lead singer may sound like it is behind the beat of the drums, as a non-limiting example.

In order to synchronise the audio channels, processing circuitry 100 may be configured to associate one or more timestamps with each audio channel, wherein a given timestamp for a given audio channel is equal to a respective timestamp of each of the other audio channels. Moreover, processing circuitry 100 may be configured to align the plurality of audio channels with respect to each other by way of matching the timestamps of the given channel with those of the other channels. Subsequently, processing circuitry 100 may be configured to simultaneously transmit the aligned plurality of audio channels to the one or more earphones/headphones 102 and the one or more BC headphones 104.

In any case, and as will be appreciated by person skilled in the art, the distribution of the audio defined in the audio file among three or more audio channels such that each channel is different from the others, and the subsequent driving of three or more wearable transducers (via an arrangement comprising both earphones/headphones 102 and BC headphones 104) with the three or more audio channels results in a richer and more immersive listening experience akin to that of conventional room-scale sound systems. Moreover, the user may enjoy such a surround sound experience while on the go; that is, without having to adopt a static position in a particular room (as has been the case heretofore).

### Transducers

Embodiments of the present description comprise three or more transducers comprised within one or more audio output apparatuses wearable by the user, wherein each transducer is an earphone/headphone or a bone conduction headphone, and wherein the three or more transducers comprise at least one earphone/headphone and at least one bone conduction headphone. For instance, the three or more transducers may comprise two earphones and one bone conduction headphone, one earphone and two bone conduction headphones, or two earphones and two bone conduction earphones. While the form of headphones/earphones may in some cases limit the number that are able to be provided for a single user, the number of bone conduction headphones may not be so limited due to the alternative transmission path.

As will be appreciated by persons skilled in the art, any type of commonly known earphones and/or headphones may be employed in embodiments of the present description. Examples of such commonly known earphones/headphones include, wired earphones, wireless earphones (also known as earbuds in some instances), wired headphones, and wireless headphones, all of which may or may not comprise a microphone.

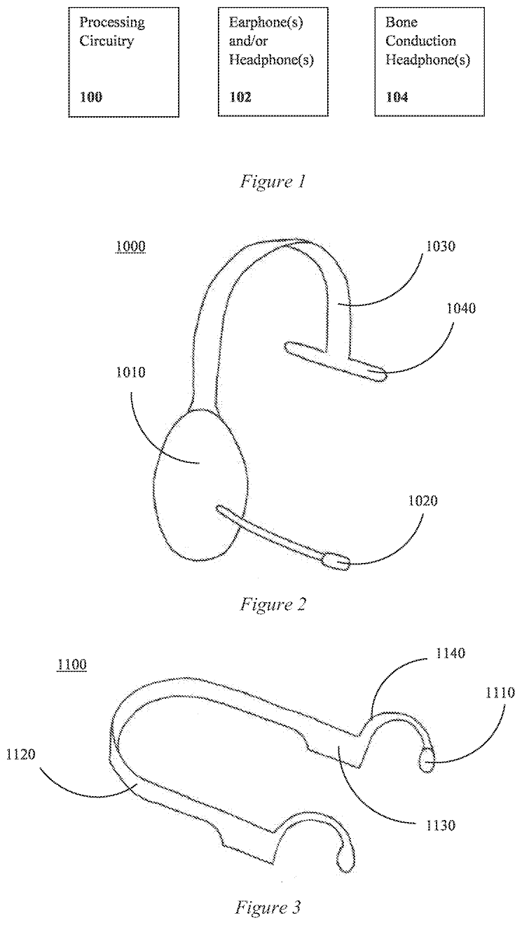

As will be appreciated by persons skilled in the art, embodiments of the present description comprise may comprise only one earphone. For example, if a commonly known pair of earbuds are being used within embodiments of the present description, then only one of those earbuds needs to be used in conjunction with a pair of BC headphones to realise the advantages described previously herein. Moreover, persons skilled in the art will readily appreciate that embodiments of the present description comprise may comprise only one headphone. For example, a video conferencing headset may be used within embodiments of the present description, an example of which being depicted in FIG. 2. As seen in FIG. 2, the headset 1000 comprises a single headphone 1000, a microphone and a headband 1030 which connects headphone 1000 to a mounting portion 1040.

FIG. 3 depicts a pair of commonly known BC headphones. BC headphones 1100 typically comprise two vibrating elements 1110, one corresponding to each car of the user. These vibrating elements are typically connected to each other by a headband 1120. Headband 1120 typically comprises two oblong portions 1130, which typically comprise a source of electrical power (such as a rechargeable battery) and transmission circuitry operable to transmit audio channels to the vibrating elements 1110, the transmission circuitry being powered by the electrical power source. The headband also comprises two arcuate shaped portions 1140 between the oblong portions 1130 and the vibrating elements 1110. These arcuate portions are typically used to hook the BC headphones over the user's ears. When the BC headphones 1100 are worn by the user, headband 1120 and arcuate portions 1140 thereof ensure that the BC headphones (vibrating elements) 1110 rest against the user's temporal bone, just in front of the user's ears.

Despite commonly known BC headphones typically comprising two BC audio output elements (vibrating elements), embodiments of the present description may comprise only one BC headphone (vibrating element), which would mean that two or more earphones/headphones 102 (a pair of earphones or headphones, or a video conferencing headset 1000 and one earbud, for example) would also be needed to provide the three or more transducers required to realise the surround sound experience to be provided to users of portable audio systems. This shall be discussed later herein.

Alternatively or in addition, the earphones/headphones 102 may be comprised within an audio output apparatus that also comprises BC headphones 104. This shall be discussed later herein.

Earphone(s) and/or Headphone(s)

In embodiments of the present description, each earphone/headphone 102 is operable to emit one or more sound signals in dependence upon a first subset of the audio channels.

As mentioned previously, each earphone/headphone 102 need not be driven by all audio channels comprised within the first subset. Rather, the first subset of audio channels should be construed as comprising those generated audio channels which are to be utilised to drive at least one of the earphones/headphones 102.

Optionally, at least one earphone/headphone is noise cancelling. This may be advantageous in that the user is provided with a more immersive listening experience; the noise cancelling capabilities of the earphone(s)/headphone(s) may serve to eliminate/reduce the volume of noises and sounds from the user's environment for the user, which may have otherwise “drowned out” the audio the user is listening to.

In any case, each earphone/headphone 102 employed in embodiments of the present description may comprise a speaker (or other transducer) that emits sound signals (that is, is driven) in dependence upon at least one of the audio channels of the first subset, such sound signals being transmitted into one of the user's ear canal. It should be noted that, given that the earphones/headphones are driven with only (a part of) the first subset of audio channels, the resulting sounds emitted from the earphones/headphones do not constitute the entirety of the listening experience intended for the user, regardless of whether or not the first subset comprises all the tracks of the audio file.

### Bone Conduction Headphone(s)

Embodiments of the present description comprise one or more bone conduction (BC) headphones 104 wearable by the user, wherein each bone conduction headphone is operable to vibrate responsive to a second subset of audio channels.

As mentioned previously, each BC headphone 104 need not be driven by all audio channels comprised within the second subset. Rather, the second subset of audio channels should be construed as comprising those generated audio channels which are to be utilised to drive at least one of the BC headphones 104.

The vibrating elements of the BC headphones emit vibrations (that is, is driven) in dependence upon at least one of the audio channels of the second subset, such vibrations being transmitted through the user's temporal bone. It should be noted that, given that the BC headphones are driven with only (a part of) the second subset of audio channels, the resulting sounds emitted from the earphones/headphones do not constitute the entirety of the listening experience intended for the user, regardless of whether or not the first subset comprises all the tracks of the audio file.

By wearing both the earphones/headphones 102 and the BC headphones 104 together to listen to the rock song (or other audio file), the two independent listening experiences are combined to form a more complete and immersive listening experience for the user; this is a result of each of the audio output methods emphasising different aspects of the output audio to generate an overall effect in consideration of the use of both of the audio output methods.

Moreover, such a listening experience may be thought as being akin to that associated with conventional surround sound systems, as three or more different audio channels are being used to drive three or more different transducers. That is to say, the audio output by embodiments of the present description comprises more distinct audio channels than that of conventional personal audio systems (which only offer stereo audio at most).

### Variant Embodiments

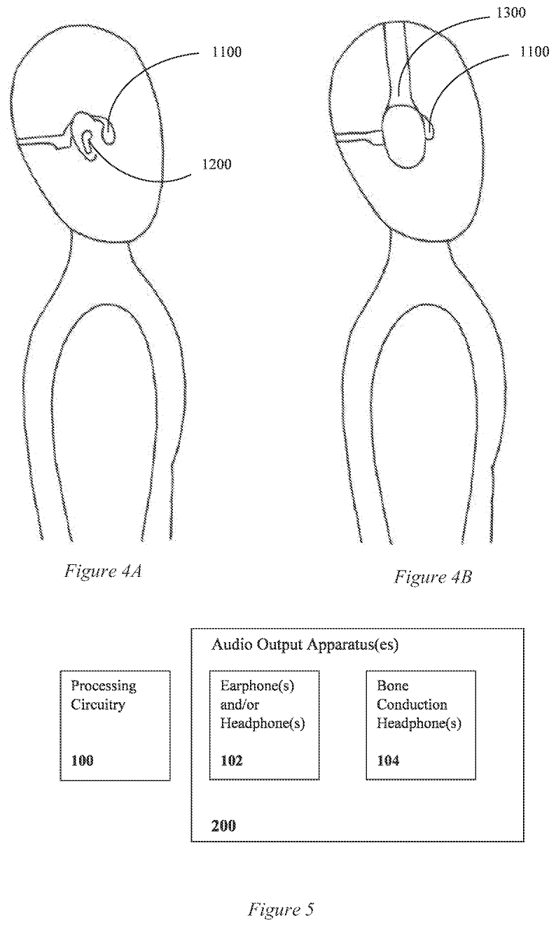

FIGS. 4A and 4B depict the non-limiting examples of a user wearing commonly known earphones/headphones and commonly known BC headphones in accordance with embodiments of the present description.

In FIG. 4A, the user is wearing one or more “off-the-shelf” earbuds 1200 and a pair of BC headphones 1100. Both earbud(s) 1200 and BC headphones 1100 may be connected via wireless connection means to the user's smartphone (not shown), which may be transmitting a first subset of audio channels (generated by the processing circuitry 100 thereof) to earbud(s) 1200 and a second subset of audio channels to BC headphones 1100.

As mentioned previously, one earbud 1200 may be used in conjunction with the pair of BC headphones 1100 in order to realise the advantages described previously herein; such an arrangement results in three transducers being worn by the user, which enables the provision of 3-channel surround sound audio to the user.

In FIG. 4B, the user is wearing one or more “off-the-shelf” headphones 1300 (which, in the case of only one headphone, may be headset 1000) and a pair of BC headphones 1100. The example and discussion with regard to FIG. 4A may be applied, mutatis mutandis, to FIG. 4B.

Optionally, and as depicted in FIG. 5, the one or more of the transducers may be comprised within one or more audio output apparatuses 200 each comprising at least one earphone or headphone 102 and at least one bone conduction (BC) headphone 104. Alternatively put, a new type of audio output apparatus may be created in order to realise the advantages of embodiments of the present description, this new type of the audio output apparatus comprising at least one carphone/headphone 102 and at least one BC headphone 104.

In order to receive audio channels (or, optionally, an audio file) from a portable audio device (mobile phone, laptop, tablet, portable games console, or the like), audio output apparatus(es) 200 may connect to the portable audio device using any commonly known wired or wireless connection methods, such as USB, Ethernet, a headphone jack/aux cable, Bluetooth®, Wi-Fi®, and the like.

Such audio output apparatus(es) may be advantageous in that embodiments of the present description may be made more ergonomic. This is because wearing two different types of off-the-shelf earphones/headphones may become uncomfortable for some users, especially for those who wear headphones and BC headphones (as in FIG. 4B), as such a combination may be placing an excessive degree of compression on and around the user's skull, cars and/or temples due to the headbands. By integrating both types of earphones/headphones into the same audio output apparatus, the number of headbands may be reduced or even eliminated, thus reducing the amount of compression placed on the user's skull, cars and/or temples while listening to surround sound audio.

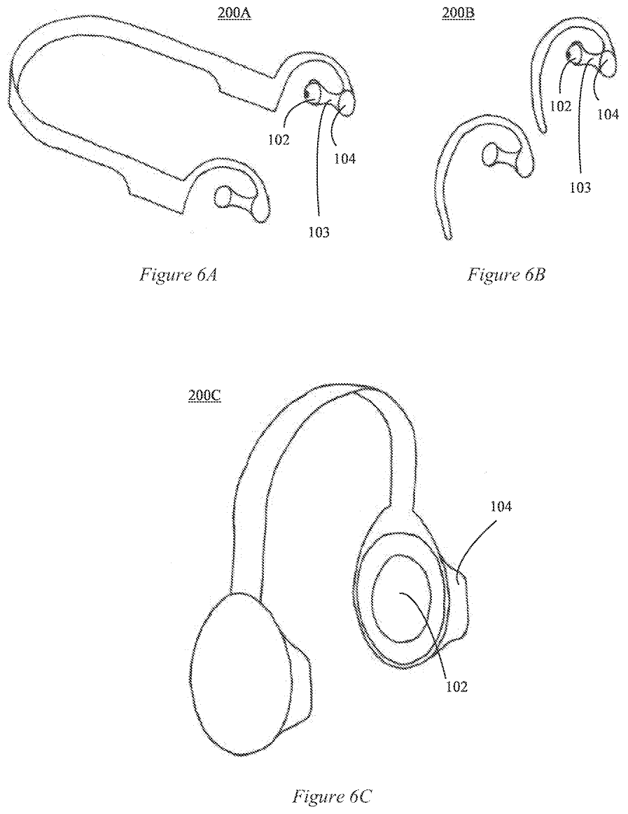

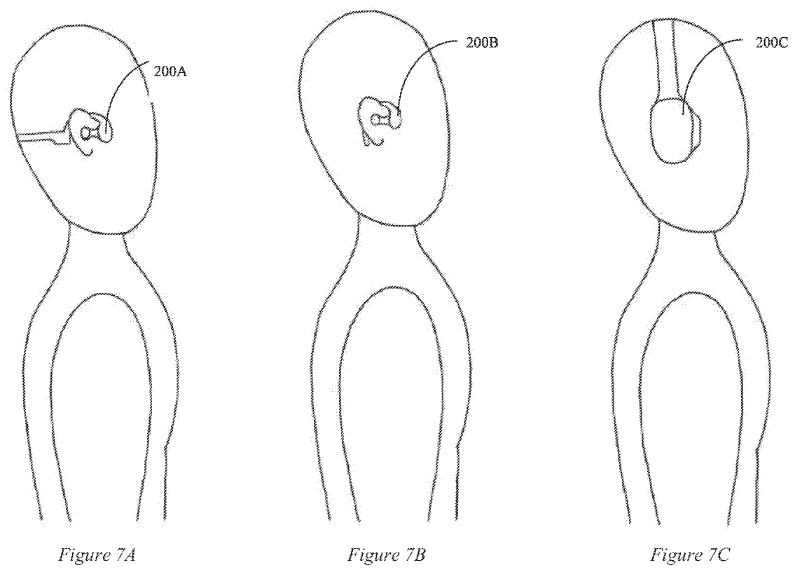

Several non-limiting examples of such audio output apparatuses are depicted in FIGS. 6A-6C. FIG. 6A depicts an audio output apparatus 200A whose shape resembles that of commonly known bone conduction headphones, such commonly known BC headphones being discussed previously with respect to FIG. 3. However, audio output apparatus 200A is different from commonly known bone conduction headphones in that an earphone 102 is connected to each bone conduction headphone (vibrating element) 104 by way of a respective connecting member 103. Of course, the device may comprise some form of dampening element to reduce vibrations between these respective elements 102 and 104 via the connecting member 103.

FIG. 6B depicts a pair of audio output apparatuses 200B whose shapes resembles that of commonly known sports earphones. Such sports earphones typically comprise arcuate members that hook over the user's ears when the sports earphones are worn. The arcuate members of the sports headphones typically enable a more secure fitting of the earphones to the user's ears, and thereby reduce the likelihood of the earphones falling out of the user's ears while the user is performing physical activity.

However, audio output apparatuses 200B are different from commonly known sports earphones in that each audio output apparatus comprises at least one BC headphone 104 in addition to at least one earphone 102 (commonly known sports earphones typically only comprise earphones, not BC headphones). As can be seen in FIG. 6B, the arcuate member for hooking over the user's ear may be connected to the BC headphone (vibrating element) 104 and the earphone 102 is connected to each BC headphone 104 by way of a connecting member 103.

Within the context of the audio output apparatuses depicted in FIG. 6B, the arcuate members thereof may serve a dual purpose; not only do they reduce the likelihood of the audio output apparatuses 200B falling out of the user's ears during physical activity, but also ensure that the BC headphones (vibrating elements) rest against the user's temporal bone. Of course, this dual purpose may also be achieved by the headband (and the arcuate portions thereof) of audio output apparatus 200A, depicted in FIG. 6A.

As will be appreciated by persons skilled in the art, the advantages of the present description may be realised by using only one audio output apparatus 200B in conjunction with one earphone/headphone 102 (headset 1000 or an earbud 1200, for example).

FIG. 6C depicts an audio output apparatus 200C whose shape resembles that of commonly known headphones, such commonly known headphones have been discussed previously. However, audio output apparatus 200C is different from commonly known headphones in that a BC headphone (vibrating element) 104 is connected to each headphone 102. Like with audio output apparatus 200A, the headband of audio output apparatus 200C may ensure that the BC headphones 104 rest against the user's temporal bone.

As will be appreciated by persons skilled in the art, a further embodiment of an audio output apparatus 200 may also be obtained by modifying headset 1000 (depicted in FIG. 2) to include a BC headphone 104 connected to the headphone 1010 thereof. In order to realise the advantages described hereinbefore, such a modified headset may be worn in conjunction with an earbud 1200, for example.

It should be noted that audio output apparatus(es) 200 need not be limited to having a maximum of two BC headphones 104 in conjunction with one or more earphones/headphones 102. Rather, given that the user's temporal bone extents towards to the user's temple and even behind the car, more than two BC headphones may be worn by the user, and the resulting vibrations may be transmitted to the user's inner ear via the temporal bone. As a non-limiting example, audio output apparatus 200A may comprise, say, 6 BC headphones (vibrating elements) 104. For example, the two vibrating elements depicted in FIG. 6A (which are situated in front of the user's car when worn) in addition to one situated on each arcuate member (and thus situated between the user's skull and the helix of the user's ear when worn), and one situated within each oblong portion (and thus situated behind the user's ear when worn). These 6 BC headphones 104, in conjunction with the two earphones 102, would enable audio output apparatus 200A to output 8 channels of the surround sound audio to the user. As will be appreciated by persons skilled in the art, similar modification may be carried out on audio output apparatuses 200B and 200C.

Several non-limiting examples of a user wearing audio output apparatus(es) 200 are depicted in FIGS. 7A-7C. FIG. 7A depicts a user wearing audio output apparatus 200A, FIG. 7B depicts a user wearing one or more audio output apparatuses 200B, and FIG. 7C depicts a user wearing audio output apparatus 200C.

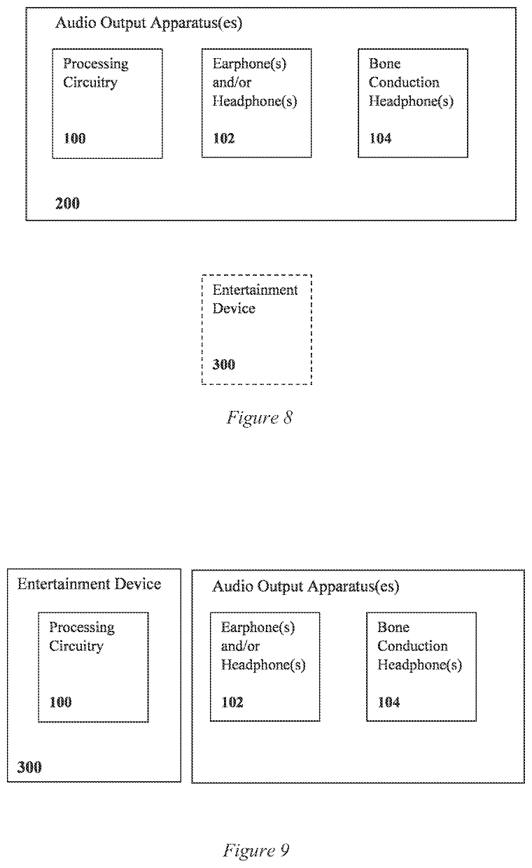

Regardless of the specific form of audio output apparatus(es) 200, skilled persons in the art will readily appreciate that processing circuitry 100 may optionally be comprised within one or more of the audio output apparatuses 200, as depicted in FIG. 8.

This may be advantageous in that audio output apparatus(es) 200 may be connectable with a greater variety of portable audio devices. For example, certain portable audio devices (especially older/legacy devices) may not have the processing power required to generate a plurality of audio channels suitable for audio output apparatus(es) 200.

Incorporating processing circuitry 100 within one or more audio output apparatus(es) 200 may therefore enable audio output apparatus(es) 200 to connect with portable audio devices that do not possess the necessary processing power, as such devices would only need to provide an audio file to audio output apparatus(es) 200.

Optionally, and as depicted in FIG. 8, where audio output apparatus(es) 200 comprise the processing circuitry 100, embodiments of the present description may comprise entertainment device 300, which may be configured to transmit the audio data to processing circuitry 100. Within the context of the present description, a portable audio device may be thought of as one type of entertainment device 300; other types of entertainment device 300 (such as a TV, desktop computer or video game console) are not typically considered to be portable in nature.

While some types of entertainment device 300 may have sufficient processing power to generate audio channels for audio output apparatus(es) 200, it may nonetheless be advantageous to incorporate processing circuitry 100 within audio output apparatus(es) 200, as doing so may reduce the processing burden placed on entertainment device 300. For example, entertainment device 300 may be a video game console that is currently executing a video game. If this video game console were to also generate a plurality of audio channels based on the video game's soundtrack and/or sound effects, then the processing burden placed on the video games console may be such that the graphics and/or audio of video game reduce in quality as a result (lower image resolution, lower audio sampling rate, missing audio channels, lower frame rate, bugs and glitches, and the like), thereby leading to a reduction in the immersiveness of the video game experience.

Alternatively, and as depicted in FIG. 9, in embodiments of the present description, processing circuitry 100 may be comprised within entertainment device 300, wherein entertainment device 300 may be configured to transmit the plurality of audio channels to the one or more audio output apparatus(es) 200.

It should be noted that entertainment device 300 is not limited to only transmitting the audio channels to audio output apparatus(es) 200; persons skilled in the art will appreciate that entertainment device 300 (comprising processing circuitry 100) may be configured to transmit the plurality of audio channels to commonly known earphones/headphones and commonly known BC headphones, as described previously.

Hence more generally, in embodiments of the present description, the processing circuitry 100 may be comprised within entertainment device 300, wherein entertainment device 300 may be configured to transmit audio channels to earphones and/or headphones 102 and BC headphones 104.

It may be advantageous to incorporate the processing circuitry 100 within entertainment device 300 as opposed to within audio output apparatus(es) 200, as otherwise audio output apparatus(es) 200 may be cause user discomfort/injury. For example, if processing circuitry 100 were to be comprised within audio output apparatus(es) 200, then processing circuitry 100 may overheat due to contact with the user's body, this being especially apparent in the case where the user is exercising and thus raising their skin temperature. This overheating may cause discomfort or even injury to users. Thus, by incorporating the processing circuitry 100 within entertainment device 300, such discomfort/injury due to overheating may be avoided/reduced, especially in the case where entertainment device 300 is not on the user's person when in use (a user playing a game on their video game console, for example).

Moreover, if processing circuitry 100 were incorporated within audio output apparatus(es) 200, then the weight of such apparatus(es) may increase (which may also cause user discomfort), and, if such apparatus(es) are wirelessly connectable with entertainment device 300, the battery life of such apparatus(es) may reduce due to a significant portion of battery power being dedicated to processing circuitry 100. Thus, by incorporating processing circuitry 100 within entertainment device 300, such user discomfort may be alleviated and the battery life of audio output apparatus(es) 200 may be increased.

Regardless of whether entertainment device 300 transmits the audio file or the generated audio channels, in embodiments of the present description, entertainment device 300 may be one selected from the list consisting of: (i) a mobile phone; (ii) a computer; (iii) a video game console; and (iv) a television.

It should be noted that the preceding list of examples are not exhaustive; persons skilled in the art will appreciate that entertainment devices other than those mentioned previously are considered within the scope of the present description.

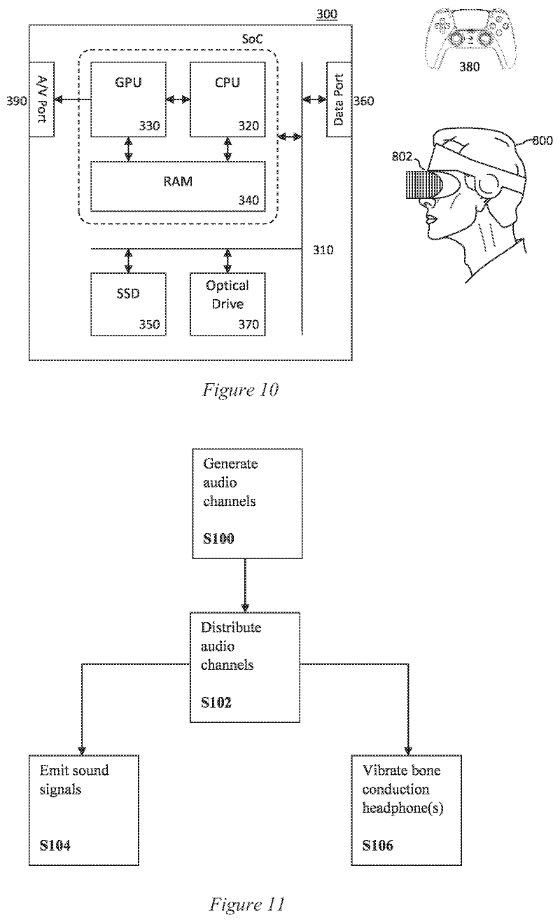

Turning to FIG. 10, a non-limiting example of an entertainment device 300 is a computer or console such as the Sony® PlayStation 5® (PS5).

The entertainment device 300 comprises a central processor 320. This may be a single or multi core processor, for example comprising eight cores as in the PS5. The entertainment system also comprises a graphical processing unit or GPU 330. The GPU can be physically separate to the CPU, or integrated with the CPU as a system on a chip (SoC) as in the PS5.

The entertainment device also comprises RAM 340, and may either have separate RAM for each of the CPU and GPU, or shared RAM as in the PS5. The or each RAM can be physically separate, or integrated as part of an SoC as in the PS5. Further storage is provided by a disk 350, either as an external or internal hard drive, or as an external solid state drive, or an internal solid state drive as in the PS5.

The entertainment device may transmit or receive data via one or more data ports 360, such as a USB port, Ethernet® port, Wi-Fi® port, Bluetooth® port or similar, as appropriate. It may also optionally receive data via an optical drive 370.

Interaction with the system is typically provided using one or more handheld controllers 380, such as the DualSense® controller in the case of the PS5.

Audio/visual outputs from the entertainment device are typically provided through one or more A/V ports 390, or through one or more of the wired or wireless data ports 360.

Where components are not integrated, they may be connected as appropriate either by a dedicated data link or via a bus 310.

An example of a device for displaying images output by the entertainment system is a head mounted display ‘HMD’ 802, worn by a user 800.

In any case, where earphones/headphones 102 and BC headphones 104 are comprised within audio output apparatus(es) 200, at least one of the audio output apparatuses 200 may be comprised within a head mounted display (such as HMD 802) or a pair of glasses.

Within the context of the present description, the “glasses” should be taken to mean one or more of a pair of prescription glasses comprising corrective lenses, a pair of sunglasses with tinted lenses, and a pair of augmented reality glasses comprising an integrated display, the integrated display typically projecting virtual elements (images, messages, notifications, social media, and the like) onto the lens(es) of the glasses.

This may be advantageous in that embodiments of the present description may be made more ergonomic. This is because wearing two different types of off-the-shelf earphones/headphones in addition to a HMD or glasses may become uncomfortable for some users, especially for those who wear a HMD, headphones and BC headphones (as in FIG. 4B), as such a combination may be placing an excessive degree of compression on and around the user's skull, ears and/or temples due to the headbands of the three. By integrating both types of earphones/headphones into the HMD or glasses, the number of headbands may be reduced, thus reducing the amount of compression placed on the user's skull, ears and/or temples while listening to audio.

Moreover, the HMD/glasses embodiments of audio output apparatus 200 may house more than two BC headphones 104. Alternatively put, the discussion regarding the incorporation of additional BC headphones 104 within audio output apparatuses 200A-200C may be applied, mutatis mutandis, to HMD/glasses embodiments of the audio output apparatus 200.

### A Method of Outputting Audio for a User

Turning now to FIG. 11, a method of outputting audio for a user comprises the following steps:

S100: generating, based at least in part on an audio file, a plurality of audio channels, as described elsewhere herein.

S102: distributing the plurality of audio channels among three or more transducers comprised within one or more audio output apparatuses wearable by the user, wherein each transducer is an carphone/headphone or a bone conduction headphone, wherein the three or more transducers comprise at least one earphone/headphone and at least one bone conduction headphone, as described elsewhere herein.

S104: emitting, in dependence upon a first subset of the audio channels, one or more sound signals from each earphone/headphone, as described elsewhere herein.

S106: vibrating, responsive to a second subset of the audio channels, each bone conduction headphones, as described elsewhere herein.

It will be apparent to a person skilled in the art that variations in the above method corresponding to operation of the various embodiments of the apparatus as described and claimed herein are considered within the scope of the present invention.

It will be appreciated that the above methods may be carried out on conventional hardware (such as entertainment device 300) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the present disclosure may be implemented in accordance with any one or more of the following numbered clauses:

1. A system for outputting audio for a user, comprising: processing circuitry configured to generate, based at least in part on an audio file, a plurality of audio channels; and three or more transducers comprised within one or more audio output apparatuses wearable by the user, wherein the three or more transducers comprise at least one earphone/headphone and at least one bone conduction headphone, wherein each earphone/headphone is operable to emit one or more sound signals in dependence upon a first subset of the audio channels, and wherein each bone conduction headphone is operable to vibrate responsive to a second subset of the audio channels.
2. A system according to clause 1, wherein the processing circuitry is configured to generate the plurality of audio channels in dependence upon one or more audio rendering parameters associated with the audio file.
3. A system according to clause 2, wherein the one or more audio rendering parameters comprise one or more selected from the list consisting of: (i) one or more head-related transfer functions, HRTFs; (ii) one or more mixing/equalisation parameters; and (iii) one or more channel indicators.
4. A system according to any preceding clause, wherein the processing circuitry is configured to synchronise the plurality of audio channels.
5. A system according to any preceding clause, wherein at least one earphone/headphone is noise cancelling.
6. A system according to any preceding clause, wherein each audio output apparatus comprises at least one earphone/headphone and at least one bone conduction headphone.
7. A system according to clause 1, wherein the processing circuitry is comprised within one or more of the audio output apparatuses.
8. A system according to clause 7, comprising an entertainment device configured to transmit the audio data to the processing circuitry.
9. A system according to clause 1, wherein the processing circuitry is comprised within an entertainment device, wherein the entertainment device is configured to transmit the plurality of audio channels to the one or more audio output apparatuses.
10. A system according to clause 8 or clause 9, wherein the entertainment device is one selected from the list consisting of: (i) a mobile phone; (ii) a computer; (iii) a video game console; and (iv) a television.
11. A system according to clause 1, wherein at least one of the audio output apparatuses is comprised within a head mounted display or a pair of glasses.
12. A method of outputting audio for a user, comprising the steps of: generating, based at least in part on an audio file, a plurality of audio channels; distributing the plurality of audio channels among three or more transducers comprised within one or more audio output apparatuses wearable by the user, wherein the three or more transducers comprise at least one earphone/headphone and at least one bone conduction headphone; emitting, in dependence upon a first subset of the audio channels, one or more sound signals from each earphone/headphone; and vibrating, responsive to a second subset of the audio channels, each bone conduction headphones.
13. A method according to clause 12, wherein the generating step comprises generating the plurality of audio channels in dependence upon one or more audio rendering parameters associated with the audio file.
14. A computer program comprising computer executable instructions adapted to cause a computer system, in conjunction with three or more transducers comprised within one or more audio output apparatuses, wherein the three or more transducers comprise at least one earphone/headphone and at least one bone conduction headphone, to perform any one of the methods of clauses 12 to 13.
15. A non-transitory, computer-readable storage medium having stored thereon the computer program of clause 14.

1. A system for outputting audio for a user, comprising:
processing circuitry configured to generate, based at least in part on an audio file, a plurality of audio channels; and
three or more transducers comprised within one or more audio output apparatuses wearable by the user, wherein the three or more transducers comprise at least one earphone/headphone and at least one bone conduction headphone,
wherein each earphone/headphone is operable to emit one or more sound signals in dependence upon a first subset of the audio channels, and
wherein each bone conduction headphone is operable to vibrate responsive to a second subset of the audio channels.

2. The system of claim 1, wherein the processing circuitry is configured to generate the plurality of audio channels in dependence upon one or more audio rendering parameters associated with the audio file.

3. The system of claim 2, wherein the one or more audio rendering parameters comprise one or more selected from the list consisting of:
i. one or more head-related transfer functions, HRTFs;
ii. one or more mixing/equalisation parameters; and
iii. one or more channel indicators.

4. The system of claim 1, wherein the processing circuitry is configured to synchronise the plurality of audio channels.

5. The system of claim 1, wherein at least one earphone/headphone is noise cancelling.

6. The system of claim 1, wherein each audio output apparatus comprises at least one earphone/headphone and at least one bone conduction headphone.

7. The system of claim 1, wherein the processing circuitry is comprised within one or more of the audio output apparatuses.

8. The system of claim 7, comprising an entertainment device configured to transmit the audio data to the processing circuitry.

9. The system of claim 1, wherein the processing circuitry is comprised within an entertainment device, wherein the entertainment device is configured to transmit the plurality of audio channels to the one or more audio output apparatuses.

10. The system of claim 8, wherein the entertainment device is one selected from the list consisting of:
i. a mobile phone;
ii. a computer;
iii. a video game console; and
iv. a television.

11. The system of claim 1, wherein at least one of the audio output apparatuses is comprised within a head mounted display or a pair of glasses.

12. A method of outputting audio for a user, comprising the steps of:
generating, based at least in part on an audio file, a plurality of audio channels;
distributing the plurality of audio channels among three or more transducers comprised within one or more audio output apparatuses wearable by the user, wherein the three or more transducers comprise at least one earphone/headphone and at least one bone conduction headphone;
emitting, in dependence upon a first subset of the audio channels, one or more sound signals from each earphone/headphone; and
vibrating, responsive to a second subset of the audio channels, each bone conduction headphones.

13. The method of claim 12, wherein the generating step comprises generating the plurality of audio channels in dependence upon one or more audio rendering parameters associated with the audio file.

14. A non-transitory machine-readable storage medium which stores computer software which, when executed by a computer, causes the computer to perform a method of outputting audio for a user, comprising the steps of:
generating, based at least in part on an audio file, a plurality of audio channels;
distributing the plurality of audio channels among three or more transducers comprised within one or more audio output apparatuses wearable by the user, wherein the three or more transducers comprise at least one earphone/headphone and at least one bone conduction headphone;
emitting, in dependence upon a first subset of the audio channels, one or more sound signals from each earphone/headphone; and
vibrating, responsive to a second subset of the audio channels, each bone conduction headphones.
